(19) United States
(12) Patent Application Publication
(10) Pub. No.: US 2007/0139334 A1
(43) Pub. Date: Jun. 21, 2007

(54) LIQUID CRYSTAL DISPLAY APPARATUS, AND APPARATUS AND METHOD OF DRIVING THE SAME

(75) Inventors: Sung-Jin HONG, Seoul (KR); Cheol-Woo PARK, Suwon-si, Gyeonggi-do (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/550,141

(22) Filed: Oct. 17, 2006

(30) Foreign Application Priority Data
Oct. 17, 2005 (KR) 2005-97402

(51) Int. Cl. G09G 3/36

(52) U.S. Cl. 345/92

(57) ABSTRACT

A source driver outputs a first data signal to a source wiring of the pixel section during a first time interval of one frame. A source driver re-outputs the first data signal to a source wiring during a second time interval which is delayed from the first time interval by a predetermined time interval. A gate driver outputs a gate signal to the gate wiring. The gate signal includes a first gate pulse outputted to the gate wiring during the first time interval and a second gate pulse outputted to the gate wiring during the second time interval. Therefore, the data voltage is re-outputted enhancing a response time of the liquid crystal molecules. Furthermore, the response time of the liquid crystal molecules is enhanced, thus improving a display quality of a moving image.

This application claims priority to Korean Patent Application No. 2005-97402, filed on Oct. 17, 2005, and all the benefits accruing therefrom under 35 USC § 119, the contents of which in its entirety are herein incorporated by reference.

### BACKGROUND OF THE INVENTION

1. Field of the Invention

The present invention relates to a liquid crystal display (“LCD”) apparatus, an apparatus for driving the LCD apparatus and a method of driving the LCD apparatus. More particularly, the present invention relates to an LCD apparatus capable of reducing a response time thereof to improve a display quality of a moving image, an apparatus for driving the LCD apparatus and a method of driving the LCD apparatus.

2. Description of the Related Art

Generally, a liquid crystal display (“LCD”) apparatus includes a lower substrate, an upper substrate that is opposite the lower substrate, and a liquid crystal layer disposed between the lower and upper substrates. The liquid crystal display panel includes a plurality of pixel sections. Each of the pixel sections includes a thin-film transistor and a liquid crystal capacitor. The thin film transistor is formed in the lower substrate. The liquid crystal capacitor is defined by a pixel electrode of the lower substrate, which is electrically connected to the thin-film transistor, a common electrode of the upper substrate and the liquid crystal layer disposed between the pixel electrode and the common electrode. The liquid crystal capacitor stores a pixel voltage according to a difference in voltages between a data voltage transferred from the thin-film transistor and a common voltage applied to the common electrode.

That is, the LCD apparatus displays an image in response to a variation of the data voltage, a storage capacitance variation of the liquid crystal capacitor, and a transmittance degree of light. A response time is defined as a time interval that a transmittance of light varies from about 10% to about 90% in the LCD apparatus. It is impossible for the transmittance of light to achieve about 100% during one frame even for an LCD apparatus having a superior or the best response time.

Also, a non-continuous point of a transmittance curve occurs in accordance to a storage capacitance variation of the liquid crystal capacitor. The non-continuous point is defined as a ‘CUSP’ point (non-continuous slope). Even when a charging quantity Qpix, which is charged in the liquid crystal capacitor, is uniform, a pixel voltage Vpix varies in accordance to a variation of the storage capacitance Clc of the liquid crystal molecules so that the CUSP point occurs. The CUSP point is described as the following Equation 1:
Qpix=Clc(s)*Vpix(s)=Clc(CUSP)*Vpix(CUSP)

As shown in Equation 1, a charging quantity Qpix, which is charged in the liquid crystal capacitor Clc, is substantially equal to a first charging quantity (Clc(s)*Vpix(s)) at an earlier driving of the LCD apparatus or a second charging quantity (Clc(CUSP)*Vpix(CUSP)) at the time interval of the occurrence of the CUSP point. The first charging quantity is defined by a first liquid crystal capacitance Clc(s) and a first pixel voltage Vpix(s). The second charging quantity is defined by a second liquid crystal capacitance Clc(CUSP) and a second pixel voltage Vpix(CUSP).

That is, although a charging quantity Qpix of the liquid crystal capacitor Clc is uniform in accordance with the charging quantity preserving rule, the capacitance of the liquid crystal capacitor gradually increases so that the pixel voltage gradually decreases.

As a result, the second pixel voltage Vpix(CUSP) is relatively lower than the first pixel voltage Vpix(s). Thus, a response time of the LCD apparatus increases by the CUSP that is a non-continuous point of the transmittance ratio curve occurred in accordance to a variation of the liquid crystal capacitance.

### BRIEF SUMMARY OF THE INVENTION

The present invention provides a liquid crystal display (“LCD”) apparatus capable of increasing a response time thereof.

The present invention also provides an apparatus of driving the above-mentioned LCD apparatus.

The present invention also provides a method of driving the above-mentioned LCD apparatus.

In an exemplary embodiment of the present invention, the LCD apparatus includes a liquid crystal display panel, a source driver and a gate driver. The liquid crystal display panel includes a pixel section. The pixel section includes a thin-film transistor electrically connected to a gate wiring and a source wiring, and a liquid crystal capacitor electrically connected to the thin-film transistor. The source driver outputs a first data signal to the source wiring during a first time interval of a frame. The source driver re-outputs the first data signal to the source wiring during a second time interval delayed from the first time interval by a predetermined time interval. The gate driver outputs a gate signal to the gate wiring. The gate signal includes a first gate pulse outputted to the gate wiring during the first time interval and a second gate pulse outputted to the gate wiring during the second time interval.

In another exemplary embodiment of the present invention, an apparatus for driving an LCD apparatus includes a plurality of pixel sections and a plurality of liquid crystal capacitors. The pixel sections are defined by a plurality of gate wirings and a plurality of date lines. A liquid crystal capacitor is formed in each of the pixel sections. The apparatus of driving an LCD apparatus includes a storing section, a source driver and a gate driver. The storing section stores a first data signal that is inputted from an external device and a second data signal that is inputted before the first data signal by a predetermined time interval. The source driver outputs the first and second data signals to the source wirings during a first time interval of a frame. The gate driver outputs a first gate pulse to a first gate wiring corresponding to the first data signal, and outputting a second gate pulse to a second gate wiring corresponding to the second data signal during the first time interval.

In still another exemplary embodiment of the present invention, there is provided a method of driving the LCD apparatus. In the above mentioned method, the LCD apparatus includes a plurality of pixel sections and a plurality of liquid crystal capacitors. The pixel sections are defined by a plurality of gate wirings and a plurality of date lines. A liquid crystal capacitor is formed in each of the pixel sections. In the method, a first data signal and a second data signal are applied to a pixel section of the plurality of pixel sections. The second data signal is outputted in a first time interval of a frame, the first time interval being at a predetermined time before the first data signal is applied to the pixel section. Then, the first data signal is re-applied to the pixel section, in a second time interval of the frame.

According to the LCD apparatus, the apparatus for driving the LCD apparatus and the method of driving the LCD apparatus, the data voltage is re-outputted, so that a response time of the liquid crystal molecules is enhanced. Furthermore, the response time of the liquid crystal molecules is enhanced, thus improving a display quality of a moving image.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram showing a liquid crystal display apparatus according to an exemplary embodiment of the present invention;

FIG. 2 is a block diagram showing a timing controller and a storage section in FIG. 1;

FIG. 3 is a waveform showing a driving type of the storage section in FIG. 2;

FIG. 4 is a waveform showing a driving type of a gate driver in FIG. 1;

FIG. 5 is a waveform of input/output signals showing a driving type according to an exemplary embodiment of the present invention;

FIG. 6 is a waveform of input/output signals showing a driving type according to another exemplary embodiment of the present invention; and

FIGS. 7A to 7D are transmittance curves showing a response time characteristics according to the present invention.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

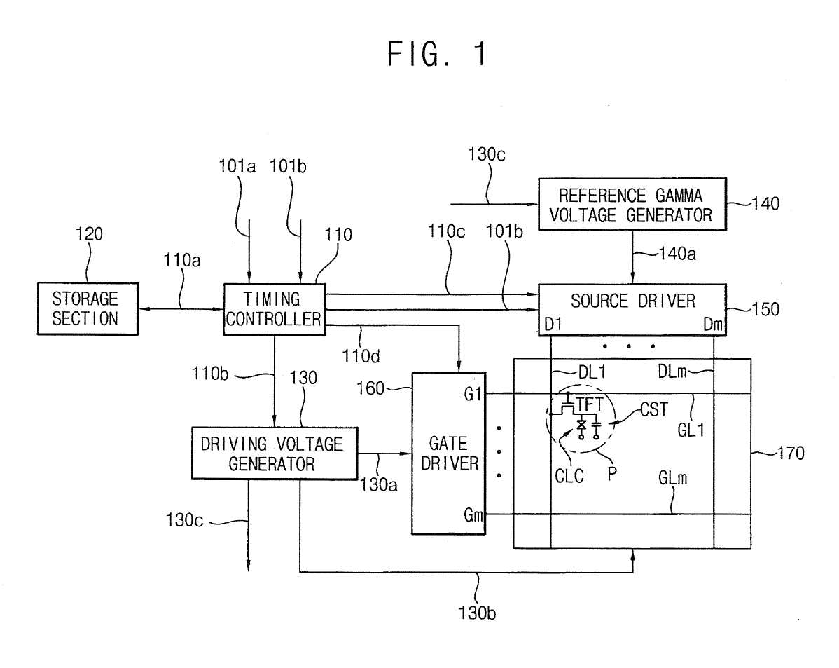

FIG. 1 is a block diagram showing a liquid crystal display apparatus according to an exemplary embodiment of the present invention.

Referring to FIG. 1, a liquid crystal display apparatus includes a timing controller 110, a storage section 120, a driving voltage generator 130, a reference gamma voltage generator 140, a source driver 150, a gate driver 160 and a liquid crystal display panel 170.

The timing controller 110 outputs a first control signal 110a, a second control signal 110b, a third control signal 110c and a fourth control signal 110d based on a control signal 101a that is applied from an external device (not shown).

The first control signal 110a controls the storage section 120. For example, the first control signal 110a includes a write signal that controls writing of the data signal to the storage section 120, and read signal that controls extracting the data signal from the storage section 120.

The second control signal 110b controls the driving voltage generating section 130. The third control signal 110c controls the source driver 150. The fourth control signal 110d controls the gate driver 160.

A data signal 101b that is inputted from the external device (not shown) is recorded in the storage section 120 in response to control of the timing controller 110, and the recorded data signal is rapidly extracted from the storage section 120 in response to control of the timing controller 110.

The data signal that is extracted from the storage section 120 during a 1H time interval includes a current line signal and a previous line signal. The current line signal corresponds to a current horizontal line. The previous line signal corresponds to a previous horizontal line that is previous to the current horizontal line.

For example, a current line signal corresponding to the (N+1)-th horizontal line and a first line signal corresponding to the first horizontal line that is previous to the (N+1)-th horizontal line are outputted during the (N+1)-th horizontal line time interval.

That is, after the first line signal is outputted to the liquid crystal display panel 170, the first line signal is re-outputted to the liquid crystal display panel 170 at a time interval (hereinafter the “CUSP time interval”), so that the first line signal is boosted to an early voltage stage. The CUSP time interval corresponds to ‘N’ number of horizontal time intervals (N×1H).

During one frame, the line signal outputted to the liquid crystal display panel 170 is re-outputted to the liquid crystal display panel 170 at a CUSP time interval, so that a response time of the liquid crystal molecules is enhanced. Furthermore, since the response time of the liquid crystal molecules is enhanced, a display quality of moving images is improved.

The driving voltage generator 130 generates a driving voltage to drive the liquid crystal display apparatus. In particular, the driving voltage generator 130 outputs a gate voltage 130a to the gate driver 160. The driving voltage generator 130 outputs common voltages 130b to the liquid crystal display panel 170. The common voltages 130b include a common voltage VCOM and a storage voltage VST. The driving voltage generator 130 outputs an analog driving voltage (AVDD) 130c to the reference gamma voltage generator 140.

The reference gamma voltage generator 140 generates 10 to 20 reference gamma voltages 140a using the analog driving voltage 130c, and outputs the generated reference gamma voltages 140a to the source driver 150.

The source driver 150 converts a data signal that is outputted from the storage section 120 into an analog data voltage. In particular, the source driver 150 converts the data signal into the analog data voltage using the third control signal 110c and the reference gamma voltages 140a, and outputs the analog data voltage to the liquid crystal display panel 170.

For example, the source driver 150 converts each of the current line signals and the previous line signals that are read out from the storage section 120 into a corresponding current line data voltage and a previous line data voltage, respectively, and outputs the current line data voltage and previous line data voltage to the source wirings DL1˜DLm at the 1H time interval. In particular, the source driver 150 outputs the current line data voltage to the source wirings DL1˜DLm during an earlier 1/2H time interval, and outputs the previous line data voltage to the source wirings DL1˜DLm during a latter 1/2H time interval.

The previous line data voltage is outputted first to the source wirings DL1˜DLm during the previous horizontal time interval. Then, the previous line data voltage is outputted second to the source wirings DL1˜DLm during a current horizontal time interval. Therefore, the previous line data voltage is outputted second to the source wirings DL1˜DLm during a CUSP time interval (a current horizontal time interval), so that a decrease in the previous line data voltage is prevented. Furthermore, a response time of the LCD apparatus is enhanced.

The gate driver 160 generates a plurality of gate signals based on the fourth control signal 110d of the timing controller 110 and the gate voltages 130b of the driving voltage generator 130, and outputs the generated gate signals to the liquid crystal display panel 170. The fourth control signal 110d may include at least two output enable signals.

The gate driver 160 sequentially outputs a plurality of gate signals to the liquid crystal display panel 170 based on the output enable signals. Each of the output enable signals may respectively correspond to a first control time interval and a second time interval. The gate driver 160 outputs a first gate pulse corresponding to the first control time interval, and outputs a second gate pulse corresponding to the second control time interval. Each of the gate signals may include the first gate pulse and the second gate pulse.

The first gate pulse is a control signal that controls charging the current line data voltage to the liquid crystal display panel 170. The second gate pulse is a control signal that controls charging the previous line data voltage to the liquid crystal display panel 170.

The liquid crystal display panel 170 includes a plurality of pixel sections P defined by a plurality of gate wirings GL1˜GLn and a plurality of source wirings DL1˜DLm. A thin-film transistor TFT, a liquid crystal capacitor CLC and a storage capacitor CST are formed in each of the pixel sections P. The common voltages VCOM and VST are applied to the liquid crystal capacitor CLC and the storage capacitor CST, respectively.

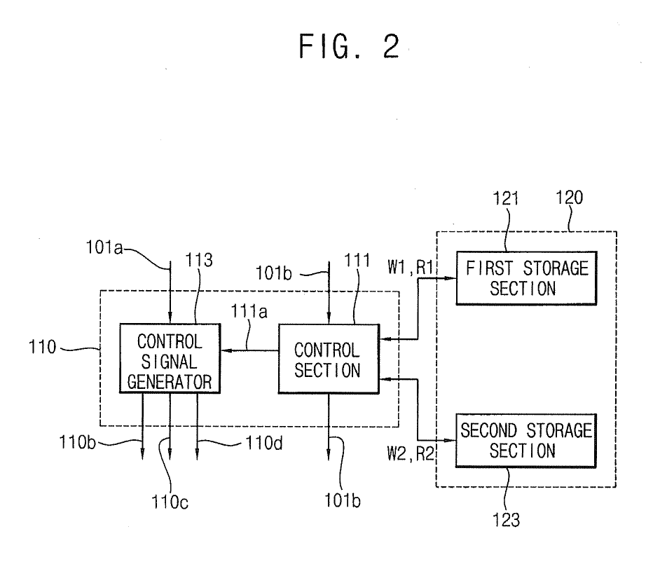

FIG. 2 is a block diagram showing a timing controller and a storage section in FIG. 1.

Referring to FIGS. 1 and 2, the timing controller 110 includes a control section 111 and a control signal generating section (depicted as “control signal generator”) 113. The storage section 120 includes a first storage section 121 and a second storage section 123.

The control section 111 controls a driving of the timing controller 110 and generates a first control signal 110a (see FIG. 1, depicted as W1, R1, W2 and R2 in FIG. 2).

The first control signal 110a controls the storage section 120. For example, the first control signal 110a includes a write signal and a read signal. The write signal controls writing the data signal to the storage section 120. The read signal controls reading the data signal from the storage section 120.

The first control signal 110a includes a first write signal W1, a first read signal R1, a second write signal W2 and a second read signal R2. The first write signal W1 controls writing the data signal to the first storage section 121, and the first read signal R1 controls reading the data signal from the first storage section 121. The second write signal W2 controls writing the data signal to the second storage section 123, and the second read signal R2 controls reading the data signal from the second storage section 123. The first write signal W1 and the first read signal R1 include an address of the first storage section 121. The second write signal W2 and the second read signal R2 include an address of the second storage section 123.

The control signal generating section 113 generates a second control signal 110b, a third control signal 110c and a fourth control signal 110d based on the control signal 101a that is inputted in response to a controlling signal 111a of the control section 111.

The control signal 101a includes a main clock signal MCLK, a horizontal synchronization signal HSYNC, a vertical synchronization signal VSYNC and a data enable signal DE. The horizontal synchronizing signal HSYNC represents a time required for displaying one line of the field. The vertical synchronizing signal VSYNC represents a time required for displaying one frame field. Thus, the horizontal synchronizing signal HSYNC includes pulses corresponding to the number of pixel sections included in one line. The data enable signal DE represents a time required for supplying the pixel section with a data signal.

The second control signal 110b is a control signal that controls the driving voltage generator 130. For example, the second control signal 110b includes a main clock signal. The third control signal 110c is a control signal that controls the source driver 150. The third control signal 110c includes a horizontal start signal STH and a load signal TP. The fourth control signal 110d is a control signal that controls the gate driver 160. The fourth control signal 110d includes a scan start signal STV, a scan clock signal CPV and at least two output enable signals OE.

The first storage section 121 writes or extracts the data signal that is inputted from an external device (not shown) in response to a control of the control section 111. In particular, the control section 111 writes the data signal based on the data enable signal DE by a horizontal line to the first storage section 121. At this time, the first storage section 121 writes the data signal based on the first write signal W1. Then, the first storage section 121 extracts the written data signal by a horizontal line, and writes the extracted data signal to the second storage section 123 by a horizontal line based on the first read signal R2.

Then, the control section 111 provides the second storage section 123 with the second write signal W2. The data signal extracted from the first storage section 121 is written in the second storage section 123 based on the second write signal W2. The second storage section 123 is, for example, a memory such as a double data rate (“DDR”) synchronous memory, and writes or reads-out the data signal at an edge of rising or falling of a clock signal. For example, when the first storage section 121 processes the data signal in 60 Hz, the second storage section 123 processes the data signal in 120 Hz.

That is, a data signal includes a current line signal and a previous line signal, which is written in the second storage section 123 during 1H time interval. The current line signal is, for example, a (N+1)-th line signal. The previous line signal is, for example, the first line signal that is written in the first storage section 121 before a predetermined time (N×1H) for the current line signal. A voltage level of the previous line data decreases by a variation of a capacitance of the liquid crystal capacitor CLC.

The previous line signal is re-outputted to the source line during a time interval that is outputted to the current line signal, so that a voltage level of the previous line signal is boosted-up or increased to an original voltage level. Herein, a CUSP time interval is (N×1H), which occurs because of a variation of a capacitance of the liquid crystal capacitor CLC.

The second storage section 123 reads-out the data signal that is written on a basis of the second read-out control signal, and outputs the read-out data signal to the source driver 150.

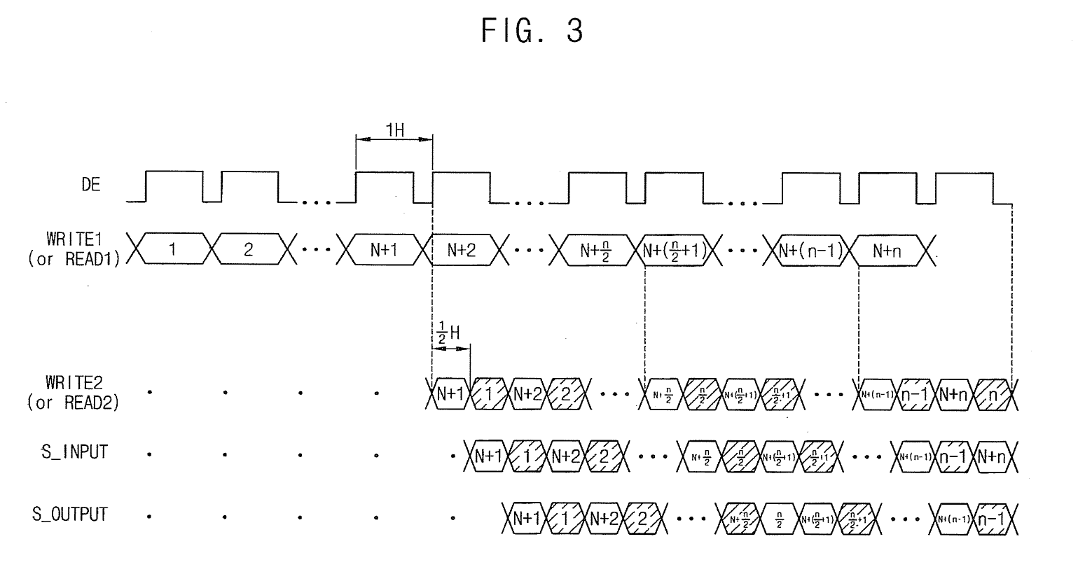

FIG. 3 is a waveform diagram showing a driving type of the storage section in FIG. 2.

Referring to FIG. 3, the control section 111 writes the inputted data signal to the first storage section 121 based on the first write signal by a horizontal line (WRITE1). At this time, the first write signal includes a data enable signal DE.

Then, the control section 111 reads out the data signal from the first storage section 121 based on the first read signal by a horizontal line, and outputs the read-out data signal.

As described above, after written in the first storage section 121 to (N+1)-th line signal (N+1), the control section 111 reads out and outputs the written data signal that is written the first storage section 121 based on the first read signal (READ1).

For example, in a CUSP time interval (N×1H) that decreases the data voltage by a variation of the liquid crystal capacitance, the control section 111 sequentially reads out the (N+1)-th line signal (N+1) and the first line signal (1) from the first storage section 121. The (N+1)-th line is separated from the first line signal (1) with N×1H.

As described above, the first storage section 121 sequentially read outs (N+1)-th line signal, first line signal, (N+2)-th line signal, second line signal, . . . (N+N/2)-th line signal, (n/2)-th line signal, (N+(N/2+1))-th line signal, (n/2+1)-th line signal, (N+(n−1)-th line signal, (n−1)-th line signal, (N+1)-th line signal and n-th line signal based on the first read signal (READ_1). Wherein, n is a total number of gate wiring and N is a natural number that is smaller than n.

The data signals that are read out from the first storage section 121 are written in the second storage section 123. The second storage section 123 is a memory such as a double data rate (“DDR”) synchronous memory, and writes or reads out the data signal at an edge of rising or falling of a clock signal. For example, when the first storage section 121 processes the data signal in 60 Hz, the second storage section 123 processes the data signal in 120 Hz.

For example, the (N+1)-th line signal (N+1) and the first line signal (1) that are read out from the first storage section 121 is stored in the second storage section 123 during 1H time interval.

The second storage section 123 sequentially stores the data signal from the first storage section 121 by a 1/2H time interval. Then, the second storage section 123 sequentially reads out and outputs the data signals that are stored in the second storage section 123 by a 1/2H time interval based on the second read signal.

For example, the second storage section 123 reads out and outputs the (N+1)-th line signal (N+1) during an earlier 1/2H time interval, then reads out and outputs the first line signal (1) during a latter 1/2H time interval. As described above, the second storage section 123 sequentially reads out (N+1)-th line signal, first line signal, (N+2)-th line signal, second line signal), . . . (N+N/2)-th line signal, (n/2)-th line signal, (N+(N/2+1))-th line signal, (n/2+1)-th line signal, . . . , (N+(n−1)-th line signal, (n−1)-th line signal, (N+1)-th line signal and n-th line signal based on the second read signal (READ 2). Wherein, n is a total number of gate wiring and N is a natural number that is smaller than n.

A data signal that is read out from the second storage section 123 is inputted to the source driver 150 (S INPUT).

The source driver 150 converts the line signal that is read out from the second storage section 123 by 1/2H time interval into an analog data voltage, and outputs the analog data voltage to source wirings DL1, . . . ,DLm of the liquid crystal display panel (S_OUTPUT).

For example, the source driver 150 converts the (N+1)-th line signal (N+1) into an analog data voltage, and outputs the analog data voltage to the source wirings DL1, . . . ,DLm during an earlier 1/2H time interval. Then, the source driver 150 converts the first line signal (1) into an analog data voltage, and outputs the analog data voltage to the source wirings DL1, . . . ,DLm during a latter 1/2H time interval.

As described above, the source driver 150 sequentially outputs (N+1)-th line data voltage, first line data voltage, (N+2)-th line data voltage, second line data voltage, . . . (N+N/2)-th line data voltage, (n/2)-th line data voltage, (N+(N/2+1))-th line data voltage, (n/2+1)-th line data voltage, . . . , (N+(n−1)-th line data voltage, (n−1)-th line data voltage, (N+1)-th line data voltage and n-th line data voltage to the source wirings DL1, . . . ,DLm (S_OUTPUT).

According to the above, a previous line data voltage that decreases according to a variation of the liquid crystal capacitance is re-outputted within 1H time interval that is outputted as the current line data voltage, so that a charging quantity of the previous line data voltage is increased. As a result, a response time of the liquid crystal molecules is enhanced, thus improving a display quality from the LCD apparatus.

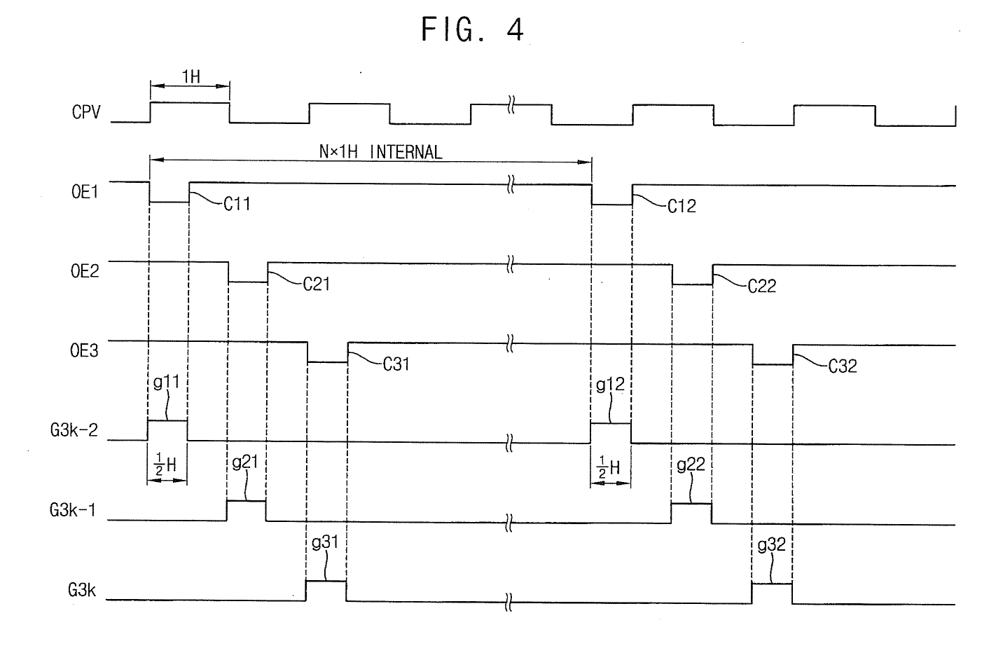

FIG. 4 is a waveform diagram showing a driving type of the gate driver 160 in FIG. 1.

Referring to FIGS. 1 to 4, the gate driver 160 outputs n number of gate signals G1˜Gn based on the fourth control signal 110d to the gate wirings GL1˜GLm of the liquid crystal display panel 170.

The fourth control signal 110d includes a scan clock signal CPV, a first output enable signal OE1, a second output enable signal OE2 and a third output enable signal OE3. The (3k-2)-th gate signals G1, G4, . . . Gn-2 are outputted based on the first output enable signal OE1, (3k-1)-th gate signals G2, G5, . . . Gn-1 are outputted based on the second output enable signal OE2, and (3k)-th gate signals G3, G6, Gn are outputted based on the third output enable signal OE3, wherein, k is a natural number.

The first, second and third output enable signals OE1, OE2 and OE3, respectively, include a first control time interval Ci1, wherein i=1, 2, 3, and a second control time interval Ci1, wherein i=1, 2, 3. The first control time interval Ci1 and the second control time interval Ci2 are spaced apart from a time different (N×1H) that is activated N number of gate wirings.

The first control time interval Ci1 corresponds to a time interval of outputting the current line data voltage from the source driver 150. The first control time interval Ci1 corresponds to the first gate pulse (gi1, i=1, 2, 3) of the gate signal that is outputted from gate driver 160. The second control time interval Ci2 corresponds to a time interval of outputting the previous line data voltage from the source driver 150. The second control time interval Ci2 corresponds to the second gate pulse (gi2, i=1, 2, 3) of the gate signal that is outputted from the gate driver 160.

For example, the first gate signal G1 has the first gate pulse gi1 and the second gate pulse g12, as illustrated in FIG. 4. A line data voltage corresponding to the (N+1)-th line (N+1) is charged by the first gate pulse gi1. A line data voltage corresponding to the first gate line is re-charged by the second gate pulse g12.

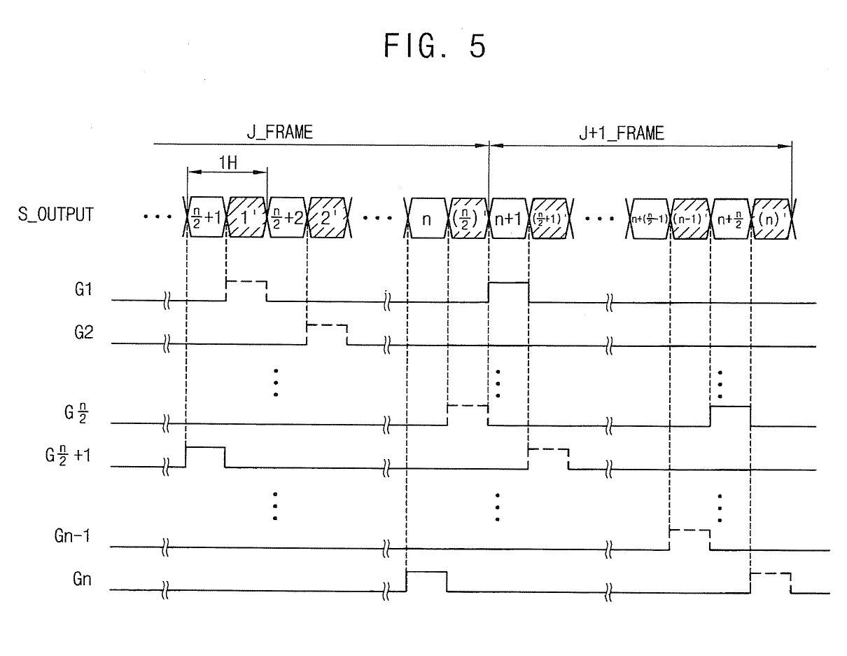

FIG. 5 is a waveform of input/output signals showing a driving type according to an exemplary embodiment of the present invention. Hereinafter, a CUSP time interval of (n/2×1H) for the LCD apparatus will be described, wherein n is a number of total gate wiring.

Referring to FIGS. 1 to 5, the source driver 150 outputs a current line signal and a previous line signal for re-outputting during a 1H time interval.

Particularly, in the CUSP time interval (n/2×1H), the source driver 150 outputs the (n/2+1)-th line signal n/2+1 of J-th frame (J_FRAME) to the source wirings DL1˜DLm during an earlier 1/2H time interval, wherein J is a natural number. At this time, the gate driver 160 outputs a (n/2+1)-th gate signal Gn/2+1 to the (n/2+1)-th gate line to the (n/2+1)-th gate line in order to activate the (n/2+1)-th gate wiring corresponding to the (n/2+1)-th line signal n/2+1.

Then, the source driver 150 outputs the first line signal 1′ of the J-th frame to the source wirings DL1˜DLm during the latter 1/2H time interval. At this time, the gate driver 160 outputs the first gate signal G1 that activates the first gate wiring corresponding to the first line signal 1′.

The source driver 150 outputs the n-th line signal (n) and n/2-th line signal (n/2)′ of the J-th frame (J_FRAME) to the source wirings DL1˜DLm. The gate driver 160 outputs the gate signals (Gn) and (Gn/2) to the gate wirings Gn and Gn/2, respectively.

Therefore, an earlier 1/2 frame data signal of the J-th frame (J_FRAME) is re-charged in the liquid crystal display panel 170 during a latter 1/2 frame of the J-th frame (J_FRAME).

Then, the source driver 150 outputs a first line signal (n+1) of the (J+1)-th frame (J+1_FRAME) and (n/2+1)-th line signal (n/2+1)′ of the J-th frame (J_FRAME) to the source wirings DL1˜DLm. The gate driver 160 outputs gate signals (G1) and (Gn/2+1) to first and (n/2+1)-th gate wirings, respectively.

The source driver 150 outputs the (n/2)-th line signal (n+n/2) of the (J+1)-th frame (J+1_FRAME) and n-th line signal (n′) of the J-th frame (J_FRAME) to the source wirings DL1˜DLm. The gate driver 160 outputs the (n/2)-th gate signals (Gn/2) and (Gn) to the n/2-th and n-th gate wirings, respectively.

Therefore, a latter 1/2 frame data signal of the J-th frame (J_FRAME) is re-charged in the liquid crystal display panel 170 during an earlier 1/2 frame of the (J+1)-th frame (J+1_FRAME).

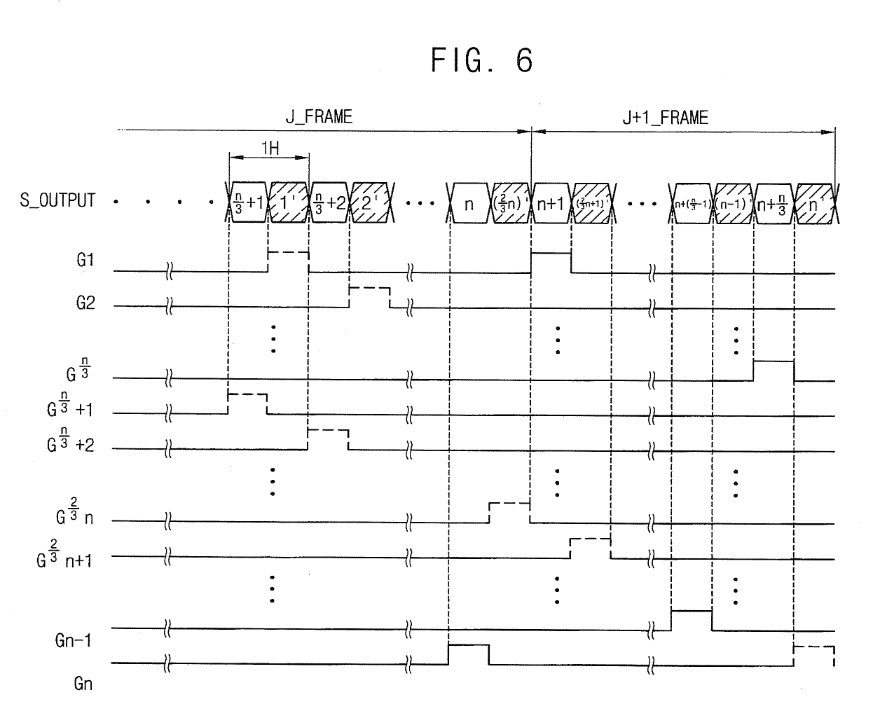

FIG. 6 is a waveform diagram of input/output signals showing a driving type according to another exemplary embodiment of the present invention. Hereinafter, a CUSP time interval of (n/3×1H) for the LCD apparatus will be described, wherein n is a number of total gate wiring.

Referring to FIGS. 1 to 6, the source driver 150 outputs a current line signal and previous line signal for re-outputting during a 1H time interval.

Particularly, in the CUSP time interval of (n/3×1H), the source driver 150 outputs the (n/3+1)-th line signal (n/3+1) of J-th frame (J_FRAME) to the source wirings DL1˜DLm during an earlier 1/2H time interval, wherein J is a natural number. At this time, the gate driver 160 outputs a (n/3+1)-th gate signal (Gn/3+1) to the (n/3+1)-th gate line Gn/3+1 in order to activate the (n/3+1)-th gate wiring corresponding to the (n/3+1)-th line signal (n/3+1).

Then, the source driver 150 outputs the first line signal (1′) of the J-th frame to the source wirings DL1˜DLm during the latter 1/2H time interval. At this time, the gate driver 160 outputs the first gate signal G1 that activates the first gate wiring corresponding to the first line signal (1′).

The source driver 150 outputs the n-th line signal (n) and 2n/3-th line signal (2n/3)′ of the J-th frame (J_FRAME) to the source wirings DL1˜DLm. The gate driver 160 outputs the gate signal (Gn) and (G2n/3) to the n-th and the 2n/3-th gate wirings, respectively.

Therefore, a latter 2/3 frame data signal of the J-th frame (J_FRAME) is re-charged in the liquid crystal display panel 170 during a latter 2/3 frame of the J-th frame (J_FRAME).

Then, the source driver 150 outputs a first line signal (n+1) of the (J+1)-th frame (J+1_FRAME) and (2n/3+1)-th line signal (2n/3+1)′ of the J-th frame (J_FRAME) to the source wirings DL1˜DLm. The gate driver 160 outputs gate signals (G1) and (Gn2n/3+1) to first and (2n/3+1)-th gate wirings, respectively.

The source driver 150 outputs the (n/3)-th line signal (n+n/3) of the (J+1)-th frame (J+1FRAME) and n-th line signal (n′) of the J-th frame (J_FRAME) to the source wirings DL1˜DLm. The gate driver 160 outputs gate signal (Gn/3) and (Gn) to the (n/3)-th and n-th gate wirings, respectively.

Therefore, a latter 1/3 frame data signal of the J-th frame (J_FRAME) is re-charged in the liquid crystal display panel 170 during an earlier 1/3 frame of the (J+1)-th frame (J+1_FRAME).

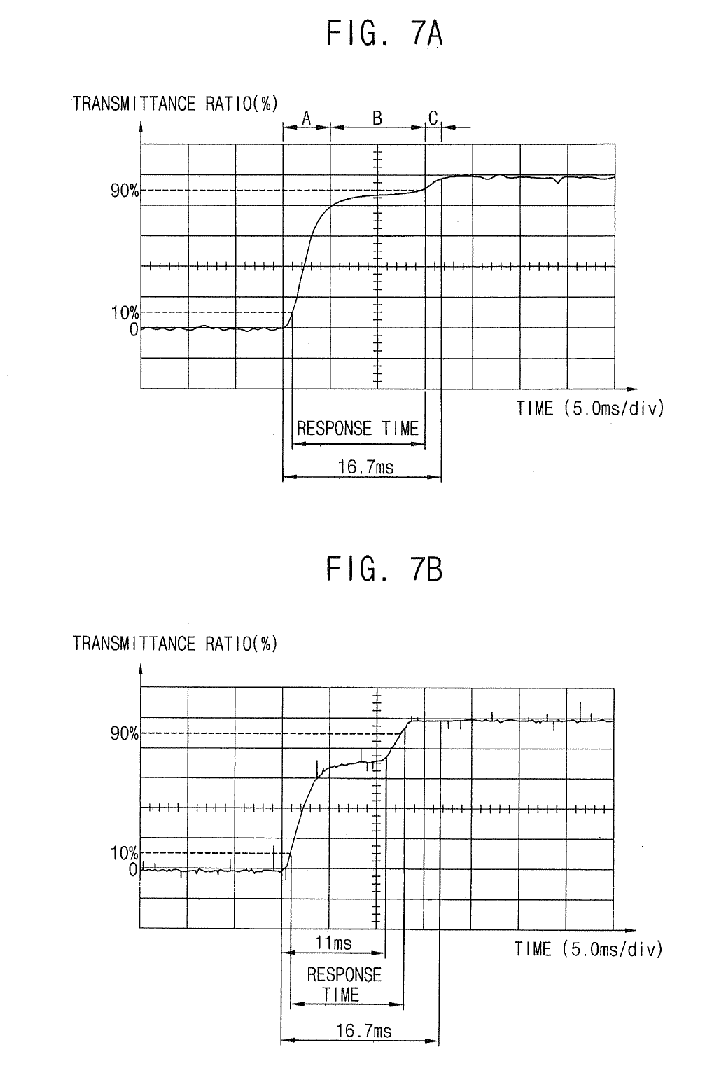

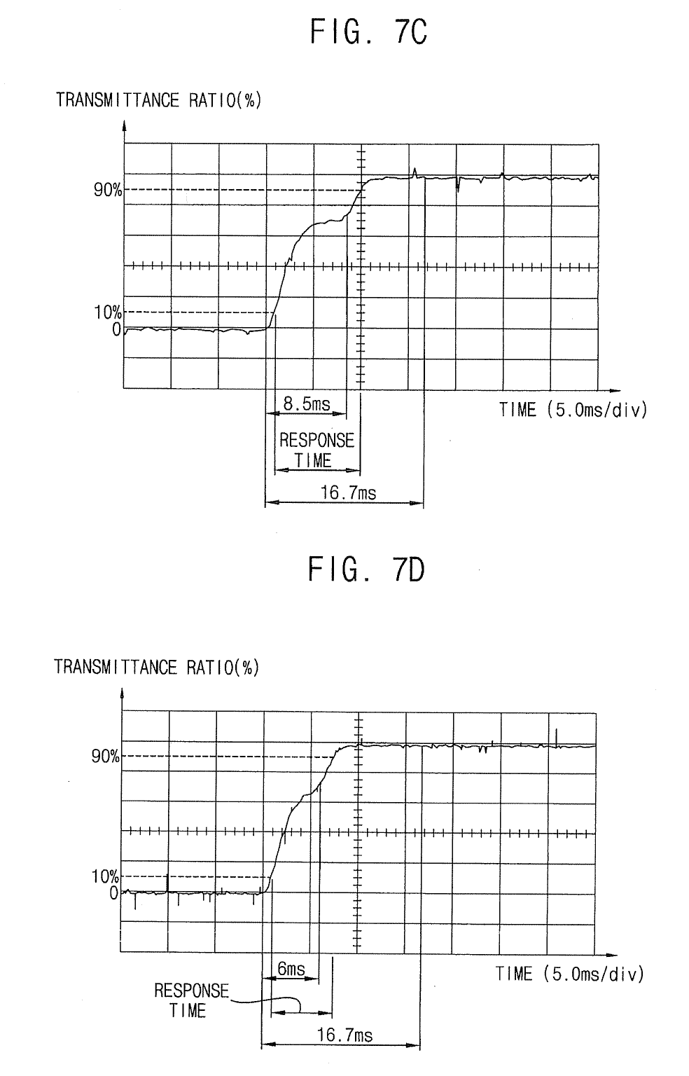

FIGS. 7A to 7D are graphs showing a relationship between an applied data voltage and a transmittance ratio. In FIGS. 7A to 7D, transmittance curves show response time characteristics according to the present invention.

FIG. 7A is a graph showing a time interval of the CUSP that has occurred for any liquid crystal.

A number of liquid crystal modes are applied in currently-used LCD apparatuses. The liquid crystal modes are generally classified into a twisted nematic (“TN”) mode, an in-plane switching (“IPS”) mode, a vertically aligned (“VA”) mode, a ferroelectric liquid crystal (“FLC”) mode, an optical compensated bend (“OCB”) mode, etc., based upon the liquid crystal type used. An occurring time interval of the CUSP in accordance with the various modes and the liquid crystal type is different from each other.

Referring to FIG. 7A, a transmittance curve for any liquid crystal molecule includes a first time interval ‘A’, a second time interval ‘B’ and a third time interval ‘C’. A transmittance ratio corresponding to the first time interval ‘A’ gradually increases, and a transmittance ratio corresponding to the second time interval ‘B’ is uniform. And, a transmittance ratio corresponding to the third time interval ‘C’ increases again. Here, a CUSP time interval is a non-continuous (non-sloping) point of the transmittance curve, that is, the second time interval ‘B’.

Generally, a response time of the liquid crystal molecules is defined as a time interval that is from about 10% to about 90% of the transmittance ratio. In FIG. 7A, a response time of normal liquid crystal molecules is about 14 milliseconds (ms).

As a result, a data voltage is re-outputted at the CUSP time interval to re-charge the liquid crystal molecules, so that a response time of the liquid crystal molecules is reduced and the response time is enhanced.

FIG. 7B is a graph showing a relationship between time of application of data voltage and a transmittance ratio when the data voltage is re-charged after 11 ms of one frame. FIG. 7C is a graph showing a relationship between time of application of data voltage and a transmittance ratio when a data voltage is re-charged after about 8.5 ms of one frame. FIG. 7D is a graph showing a relationship between time of application of data voltage and a transmittance ratio when a data voltage is re-charged after about 6 ms of one frame.

Referring to FIGS. 7A and 7B, when the data voltage was charged after 11 ms of one frame, a response time of the liquid crystal molecules was about 12 ms, thereby reducing the normal response time by about 2 ms.

Referring to FIGS. 7A and 7C, when the data voltage was charged after 8.5 ms of one frame, a response time of the liquid crystal molecules was about 9 ms, thereby reducing about 5 ms than the normal response time by about 5 ms.

Referring to FIGS. 7A and 7D, when the data voltage was charged after 6 ms of one frame, a response time of the liquid crystal molecules was about 6 ms, thereby reducing the normal response time by about 8 ms.

According to the above, the data voltage is re-outputted at a CUSP time interval since the data voltage is reduced according to a variation of the liquid crystal capacitance, so that a response time of the liquid crystal molecules is enhanced. Furthermore, since the response time of the liquid crystal molecules is enhanced, a display quality of a moving image is improved.

Although the exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A liquid crystal display (LCD) apparatus comprising:
a liquid crystal display panel including a pixel section, the pixel section including a thin-film transistor electrically connected to a gate wiring and a source wiring, and a liquid crystal capacitor electrically connected to the thin-film transistor;
a source driver outputting a first data signal to the source wiring during a first time interval of a frame, and re-outputting the first data signal to the source wiring during a second time interval that is delayed from the first time interval by a predetermined time interval; and
a gate driver outputting a gate signal to the gate wiring, the gate signal including a first gate pulse that is outputted to the gate wiring during the first time interval and a second gate pulse that is outputted to the gate wiring during the second time interval.

2. The LCD apparatus of claim 1, wherein the predetermined time interval is shorter than the frame.

3. The LCD apparatus of claim 2, wherein the predetermined time interval is set to be a time interval during which a voltage level of the first data signal is reduced to a predetermined voltage level by varying of a capacitance of the liquid crystal capacitor.

4. The LCD apparatus of claim 1, wherein each pulse width of the first and second gate pulses corresponds to a 1/2H time interval.

5. The LCD apparatus of claim 1, wherein the source driver re-outputs the second data signal that is outputted to the source wiring before the predetermined time interval during a time of outputting the first data signal.

6. The LCD apparatus of claim 5, wherein the gate driver outputs a second gate pulse to a gate wiring corresponding to the second data signal.

7. The LCD apparatus of claim 3, wherein the source driver outputs a third data signal during the second time interval, and
the third data signal is outputted to the source wiring after the predetermined time interval during a time of outputting the first data signal.

8. The LCD apparatus of claim 7, wherein the gate driver outputs a first gate pulse to a gate wiring corresponding to the third data signal.

9. The LCD apparatus of claim 5, further comprising:
a first storing section storing a data signal inputted from an external device;
a second storing section storing the first and second data signals of the data signals that are stored in the first storing section during a 1H time interval; and
a controlling section outputting the first and second data signals that are extracted from the second storing section to the source driver.

10. The LCD apparatus of claim 9, wherein the second storing section is a double data rate (DDR) synchronous memory.

11. An apparatus for driving a liquid crystal display (LCD) apparatus including a plurality of pixel sections that are defined by a plurality of gate wirings and a plurality of date lines, and a plurality of liquid crystal capacitors each formed in a respective pixel section, the apparatus for driving the LCD apparatus comprising:
a storing section storing a first data signal inputted from an external device and a second data signal inputted before the first data signal by a predetermined time interval;
a source driver outputting the first and second data signals to the source wirings during a first time interval of a frame; and
a gate driver outputting a first gate pulse to a first gate wiring corresponding to the first data signal, and outputting a second gate pulse to a second gate wiring corresponding to the second data signal during the first time interval.

12. The apparatus of claim 11, wherein the predetermined time interval is shorter than the frame.

13. The apparatus of claim 12, wherein the predetermined time interval is set to be a time during which a voltage level of the first data signal is reduced to a predetermined voltage level by varying of a capacitance of a corresponding liquid crystal capacitor of the plurality of liquid crystal capacitors for the respective pixel section.

14. The apparatus of claim 11, wherein the source driver re-outputs the first data signal to the respective pixel section, in a second time interval that is delayed from the first time interval by the predetermined time interval.

15. The apparatus of claim 14, wherein the source driver outputs a second gate pulse to the first gate wiring during the second time interval.

16. The apparatus of claim 14, wherein the source driver outputs a third data signal during the second time interval.

17. The apparatus of claim 16, wherein the gate driver outputs a first gate pulse to a third gate wiring corresponding to the third data signal.

18. A method of driving a liquid crystal display (LCD) apparatus including a plurality of pixel sections defined by a plurality of gate wirings and a plurality of date lines, and a plurality of liquid crystal capacitors each formed in a respective pixel section, the method comprising:
applying a first data signal and a second data signal that is outputted a predetermined time interval before the first data signal to the respective pixel section, in a first time interval of a frame; and
re-applying the first data signal to the pixel section, in a second time interval of the frame.

19. The method of claim 18, wherein applying the first data signal and the second data signal to the pixel section, comprises:
outputting the first data signal and the second data signal to the source wiring, the second data signal being output in a first time interval of the frame before the first data signal by the predetermined time interval; and
outputting a first gate pulse that activates a gate wiring corresponding to the first data signal, and a second gate pulse that activates a gate wiring corresponding to the second data signal, in the first time interval.

20. The method of claim 18, wherein re-applying the first data signal comprises:
re-outputting a first data signal to the respective pixel section, in a second time interval that is delayed from the first time interval by the predetermined time interval; and
outputting a second gate pulse that activates a gate wiring corresponding to the first data signal, in the second time interval.

21. The method of claim 18, further comprising:
outputting a third data signal in the second time interval after the first data signal by the predetermined time interval.

22. The method of claim 21, further comprising:
outputting a first gate pulse that activates a gate wiring corresponding to the third data signal, in the second time interval.

23. The method of claim 19, wherein each pulse width of the first and second gate pulses corresponds to about a 1/2H time interval.

24. The method of claim 20, wherein the predetermined time interval is shorter than the frame,
and the predetermined time interval is set to be a time during which a voltage level of the first data signal is reduced to a predetermined voltage level by varying of a capacitance of the liquid crystal capacitor.
